(19) United States
(12) Patent Application Publication
(10) Pub. No.: US 2005/0254084 A1
(43) Pub. Date: Nov. 17, 2005

(54) Notifying method, information processing apparatus, and control program

(75) Inventor: Takashi Imoto, Yokohama-shi, Kanagawa-ken (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/522,625

(22) PCT Filed: Aug. 25, 2003
(86) PCT No.: PCT/JP03/10701

§ 371 Date: Jan. 31, 2005

(30) Foreign Application Priority Data
Aug. 29, 2002 (JP) 2002-250765

(51) Int. Cl. G06K 1/00; G06F 15/00

(52) U.S. Cl. 358/1.15

(57) ABSTRACT

As an example of an embodiment, there is disclosed a notifying method of notifying the user of information regarding an apparatus in an information processing apparatus which can simultaneously provide an environment, as a user session, which can activate a user's desired program to each of a plurality of users. This method has: an obtaining step of obtaining the information regarding the apparatus; a specifying step of specifying the user session which uses a display unit of the information processing apparatus; and an activating step of activating a display program for displaying the information obtained in the obtaining step by the user session specified in the specifying step.

### TECHNICAL FIELD

The invention relates to a notifying method and an information processing apparatus for notifying the proper user of information regarding an apparatus, for example, information regarding a print job in a printing apparatus and information regarding a status.

### BACKGROUND ART

Hitherto, as a method of notifying the user of information regarding a print job and a status of a printer, there is a method whereby a job management application program or a printer driver program (also abbreviated to a printer driver) having a function equivalent to such a job management application program notifies the user of such information as mentioned above.

However, in the case of the job management application program or the printer driver, the user himself selects an icon of a printer corresponding to a physical printer which needs the information and illustratively designates the physical printer, thereby browsing such information as mentioned above. Thus, unless the user designates the printer, he cannot be notified of the information.

Therefore, there is a method whereby the job management application program or the printer driver is automatically activated in accordance with predetermined conditions so that it is possible to automatically notify the user of the information.

However, a computer in a multiuser environment has the following problems in the case of automatically activating the job management application program or the printer driver.

In the computer in the multiuser environment, a plurality of users can simultaneously log-on (log-in) and an application program (also abbreviated to an application) can be activated by each of a plurality of user sessions. The user session denotes that a certain user logs-in to the computer, and the user can activate various applications by the user session corresponding to himself.

The number of user sessions which can display various information onto a display is equal to one and such a user session is called an active session. Only the application which is activating in the active session can display the information onto the display. The applications activated by the user sessions other than the active session cannot display the information onto the display.

There is a problem such that even in the case where the job management application is automatically activated in order to notify a certain user of the information, if the activated user session is the non-active session, the information is not displayed onto the display and no user can be notified of the information.

### DISCLOSURE OF THE INVENTION

The invention is made to solve at least one of the foregoing problems and it is an aspect of the invention to provide a mechanism which can notify the proper user of information even in a multiuser environment.

To accomplish the above aspect, according to the invention, there is provided a notifying method of notifying a user of information regarding an apparatus in an information processing apparatus which can simultaneously provide an environment, as a user session, which can activate a user's desired program to each of a plurality of users, comprising: an obtaining step of obtaining the information regarding the apparatus; a specifying step of specifying the user session which uses a display unit of the information processing apparatus; and an activating step of activating a display program for displaying the information obtained in the obtaining step by the user session specified in the specifying step.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram showing a computer in a multiuser environment;

FIG. 2 is a diagram showing software layers in the multiuser environment of the computer;

FIG. 3 is a block diagram showing a flow of data between the computer and a printer;

FIG. 4 is comprised of FIGS. 4A and 4B illustrating flowcharts showing processes which are executed by a data transmission/reception control program and a job management application;

FIG. 5 is a diagram showing software layers of the computer in the multiuser environment;

FIG. 6 is a schematic diagram showing a print queue corresponding to printers;

FIG. 7 is a flowchart showing processes of the job management application;

FIG. 8 is a block diagram showing a flow of the data among the computers and the printer;

FIG. 9 is a flowchart showing processes which are executed by the data transmission/reception control program;

FIG. 10 is a diagram showing print data to which a computer name has been added;

FIG. 11 is a block diagram of the computer;

FIG. 12 is a diagram showing an example of a user information file;

FIG. 13 is a flowchart showing processes which are executed by the data transmission/reception control program; and

FIG. 14 is comprised of FIGS. 14A and 14B illustrating flowcharts showing processes which are executed by the job management application.

### BEST MODE FOR CARRYING OUT THE INVENTION

An embodiment according to the invention will be described hereinbelow with reference to the drawings.

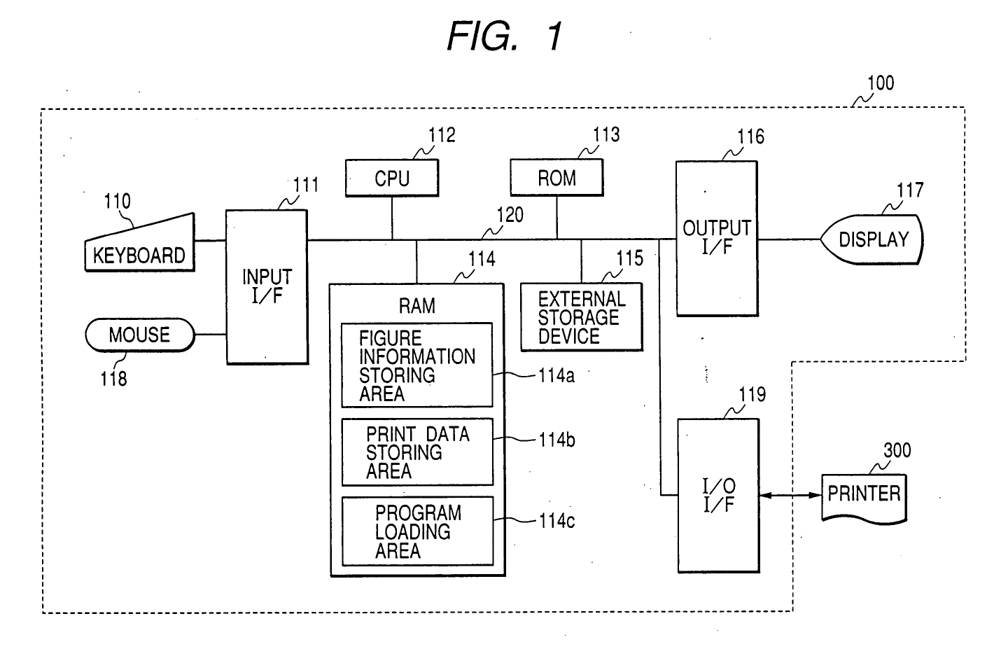

FIG. 1 is a block diagram showing a computer in a multiuser environment.

A computer 100 is an information processing apparatus such as PC, workstation, personal digital assistant, or the like and has the following units. A keyboard 110 and a mouse 118 are devices which are used for the user to input various information. An input interface 111 is an interface for connecting the information input devices such as keyboard 110, mouse 118, and the like to a bus 120.

A display 117 is a display apparatus for displaying information to the user. A CRT, a liquid crystal display apparatus, or the like can be mentioned as a display 117. An output interface 116 is an interface for connecting the display 117 to the bus 120.

A printer 300 is a printing apparatus for printing onto a recording medium on the basis of print data which is transmitted from the computer 100. As a typical printer, a laser beam printer, an ink jet printer, or the like can be mentioned. However, it is not necessary that the printer 300 is limited to the printing apparatus but an image processing apparatus such as copying apparatus, hybrid apparatus, facsimile apparatus, or the like or another external apparatus can be used. An input/output interface 119 is an interface for establishing the connection to the printer 300 and the like. A network interface, a Centronics interface, a parallel interface, a USB, an SCSI, an IEEE1394, a wireless interface, or the like can be mentioned as an I/O interface 119.

An initializing program of the computer has been stored in a ROM 113. A program of an operating system, which will be explained hereinlater, and other application programs have been stored in an external storage device 115. A RAM 114 has a figure information storing area 114a, a print data storing area 114b, a program loading area 114c. A CPU 112 executes various information processes in accordance with various programs stored in the ROM 113, external storage device 115, and RAM 114 and controls the above-mentioned units, respectively.

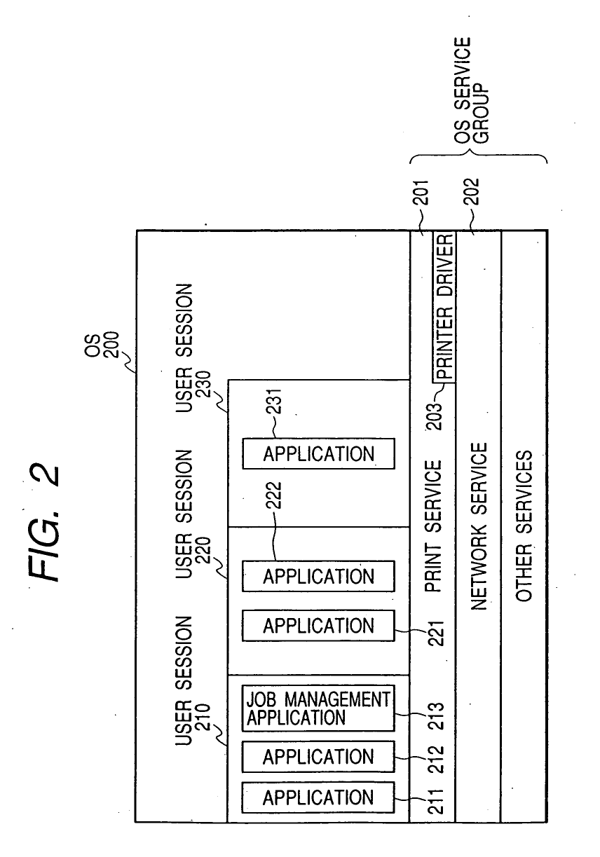

FIG. 2 is a diagram showing software layers in the multiuser environment of the computer. An operating system (hereinafter, also abbreviated to “OS”) 200 having a function for providing the multiuser environment is a platform which can control a plurality of user sessions. User's desired applications have been activated in each of user sessions 210, 220, and 230.

In FIG. 2, an application 211, an application 212, and a job management application 213 have been activated in the user session 210. An application 221 and an application 222 have been activated in the user session 220. An application 231 has been activated in the user session 230.

The OS service group is a service program group which is provided by the OS. Only one of the service programs has been activated for the OS irrespective of the number of user sessions and has been activated even if there is no active session. Although a print service 201 and a network service 202 have been shown as examples in FIG. 2, other services also exist ordinarily.

As already mentioned, even when three user sessions exist, the number of active sessions which occupy the function for displaying information onto the display is equal to 1. For example, if the user session 220 is the active session, it is seen only as applications 221 and 222 from the desk-top PC and the applications 211 to 213 and 231 cannot be seen.

When the printing is executed by the application 211 or 212, the job management application 213 operates in an interlocking relational manner with a printer driver 203 as one of the print services. If the user session 210 is the active session, the job management application 213 can display information regarding a print job and a status of the printer onto the display. However, if another user session is the active session, those information cannot be displayed and no user can confirm those information.

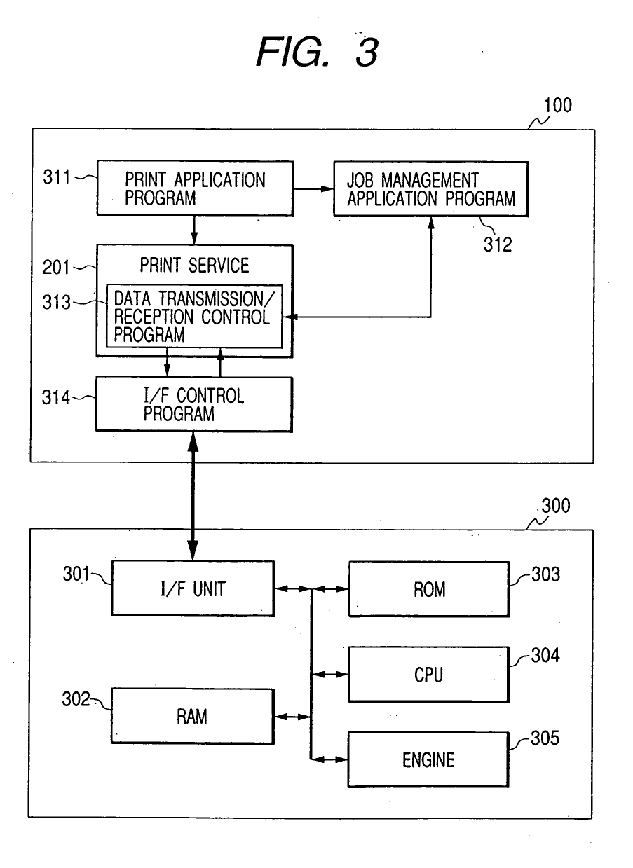

FIG. 3 is a block diagram showing a flow of data between the computer 100 and the printer 300. In the computer 100, a print application program 311 is a program for providing a drawing environment and a print environment to the user and instructing the print start.

The print service 201 is a program group which is used for the OS to provide the print service and includes the printer driver and the like. Figure information outputted from the print application program 311 is converted into a printer command in the print service 201, so that print data is formed. The print data is transferred to a data transmission/reception control program 313 on a unit basis of a print data block of a predetermined size.

The data transmission/reception control program 313 transmits the received print data block to the printer 300 via an interface control program 314. Together with the transmission, the data transmission/reception control program 313 requests the next print data block of another program in the print service 201. The interface control program 314 is a program for managing the input/output interface 119. The data transmission/reception control program 313 continues the above process until all print data blocks are transferred to the printer 300. On the other hand, the data transmission/reception control program 313 obtains the information regarding the status of the printer 300 via the interface control program 314.

A job management application 312 is an application for managing the information regarding the print job and the status of the printer. The job management application 312 communicates with the data transmission/reception control program 313 by using a communicating method such as a mail slot or the like and obtains the information regarding the print job and the status of the printer. The job management application 312 notifies the user of the received information and transfers an instruction from the user to the data transmission/reception control program 313.

The program group of the print service 201 is not individually activated every user session but is activated even if the active session does not exist.

Although a share of the processes of the host computer has been shown as mentioned above as an example in the embodiment, the invention is not limited to it.

The printer 300 has an interface unit 301, a RAM 302, a ROM 303, a CPU 304, and a printer engine 305. The interface unit 301 is an interface for establishing the connection to the outside. A control program has been stored in the ROM 303. The CPU 304 controls each unit in the printer 300 in accordance with the control program stored in the ROM 303. The RAM 302 is used as a main memory and a work memory of the CPU 304 and is also used as a reception buffer for temporarily storing the print data transmitted from the computer 100. The printer engine 305 prints onto a recording medium on the basis of the data stored in the RAM 302.

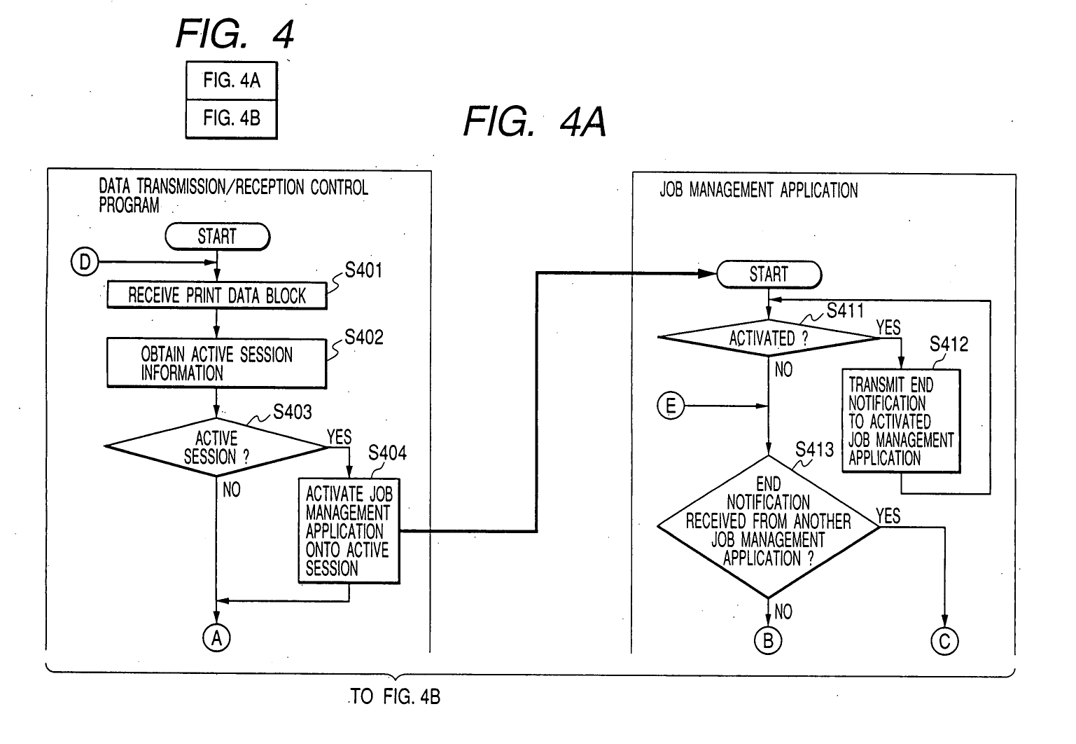

FIGS. 4A and 4B are flowcharts showing processes which are executed by the data transmission/reception control program 313 and the job management application 312. In FIGS. 4A and 4B, the processes which are executed by the data transmission/reception control program 313 are shown on the left side and the processes which are executed by the job management application 312 are shown on the right side. Big arrows indicate that data is transferred.

When the data transmission/reception control program 313 receives the print data block (step S401), it obtains the active session information (step S402) and specifies the user session which is at present the active session. As a method of specifying the active session, for example, the program 313 inquires of a multiuser management service included in the service group of the OS.

If the active session does not exist (step S403), that is, if no user occupies the desk-top PC, since there is no need to display the status information, step S405 follows. If the active session exists, the job management application is activated by the active session (step S404).

Subsequently, the status information (also including the information regarding the print job) of the printer 300 is obtained via the interface control program 314 (step S405).

The data transmission/reception control program 313 receives a message (451) from the job management application in parallel with the series of operations mentioned above and confirms whether the job management application has already been activated or not. Therefore, whether the job management application has already been activated or not is discriminated (step S406). If it is not activated, step S408 follows. If the job management application has already been activated, the obtained status information is transmitted (452) to the job management application as a message (step S407).

Subsequently, a process for transmitting the print data block to the printer 300 is executed (step S408). After that, whether all print data has been received or not, that is, whether the printing has been finished or not is discriminated (step S409). If the printing is not finished, step S401 follows. If the printing has been finished, a message (453) showing an end command is transmitted to the job management application (step S410).

First, the job management application activated in step S404 confirms whether another job management application has already been activated in the same user session or not (step S411). If another job management application has been activated, an end notification is made to the job management application (step S412).

Although the end notification (notification of an end message) has been made here in order to make exclusive control of the job management application, there is also a method of making the exclusive control by using a semaphore or the like. Although the job management application which has been activated first is finished here, if another job management application has been activated, it is also possible to finish the job management application which was activated later or not to activate the job management application later. It is also possible to control so that the data transmission/reception control program 313 finishes one of the job management applications.

Subsequently, whether the end notification has been received from another job management application or not is confirmed (step S413). If it has been received, the processing routine is finished.

If the end notification is not received from another job management application, in order to notify the data transmission/reception control program 313 that the self job management application has been activated, the message (451) showing the existence is transmitted to the data transmission/reception control program 313 (step S414).

After that, whether the message has been transmitted from the data transmission/reception Control program 313 or not is discriminated (step S415). If the message is not transmitted, the processing routine is returned to step S413. If the message showing the end command has been transmitted (step S416), the processing routine is finished. If the message showing the status information has been transmitted instead of the message indicative of the end command, the information regarding the status of the printer and the information regarding the print job are displayed on the display (step S417).

Thus, since the information regarding the status of the printer and the information regarding the print job are displayed on the display by the job management application activated in the active session, one of the users can be certainly notified of the necessary information.

If there is no active session, since the job management application is not carelessly activated, resources of the system, for example, processing resources of the CPU or memory resources are not wastefully consumed.

When the printing is finished, since the end notification is made to the job management application, the job management application can be automatically finished.

since a plurality of job management applications are not carelessly activated, the system resources are not wastefully consumed.

Subsequently, a method of notifying the user who instructs the printing of the information regarding the print job and the printer status will be described. Thus, when a plurality of users log-in to the computer, since the user who needs the information regarding the print job and the printer status is the user who printed, it is prevented that the user who does not print is unnecessarily notified of the information.

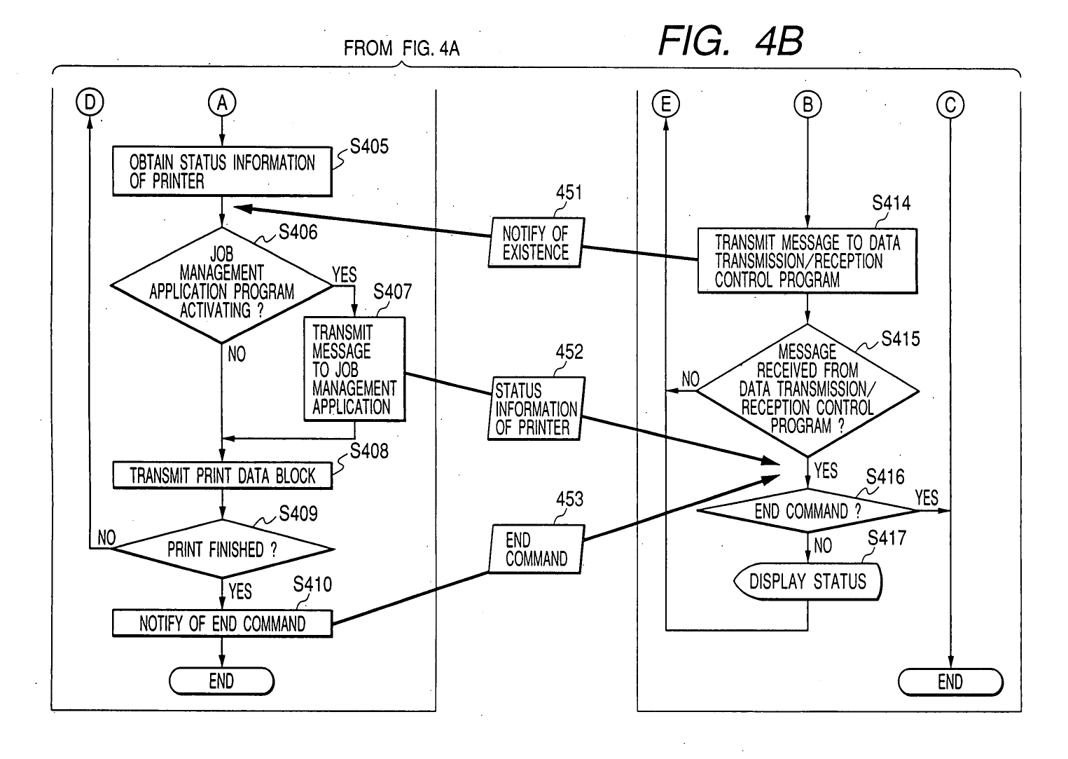

FIG. 5 is a diagram showing that a job management application 232 has been further activated in the state of FIG. 2. In FIG. 5, the job management application has been activated in each of a plurality of user sessions. A plurality of job management applications can be activated by another process on the basis of the same program code.

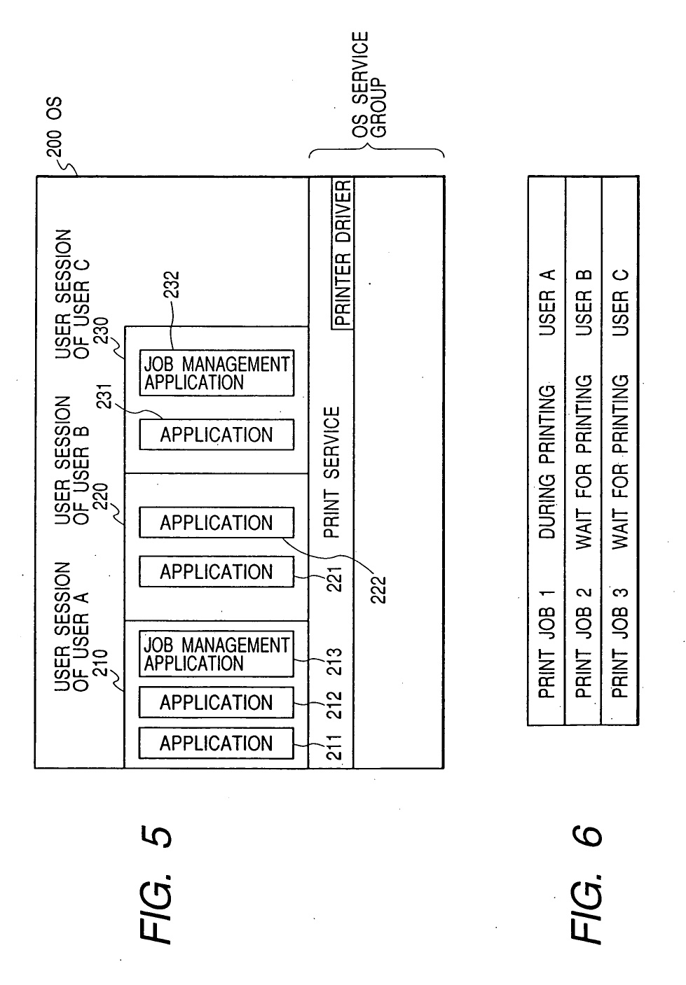

Further, FIG. 6 is a schematic diagram showing a print queue corresponding to the printer 300. The print job issued to the printer corresponding to the print queue has been inputted in the print queue. A print job 1 and a print job 2 have been inputted as print jobs of the user A and a print job 3 has been inputted as a print job of the user C into the print queue of FIG. 6.

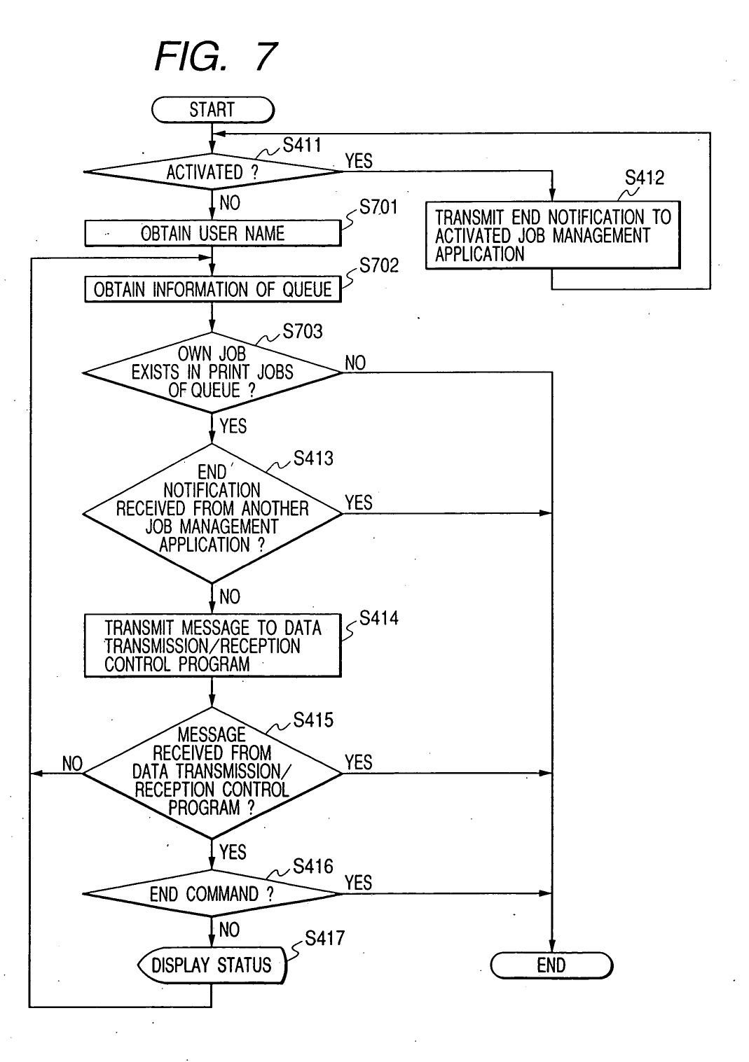

FIG. 7 is a flowchart showing processes of the job management application for activating a print management application by the user session corresponding to the user who instructed the printing. Since FIG. 7 is obtained by adding step S701 to S703 to the flowchart of FIGS. 4A and 4B, other steps are substantially the same as the corresponding steps in FIGS. 4A and 4B.

In FIG. 7, after the activation, the job management application inquires of the OS about the user name corresponding to the user session activated by itself (step S701). After that, the information regarding the print queue as shown in FIG. 6 is obtained from the print service (step S702).

The user name obtained in step S701 is compared with the information regarding the print queue obtained in step S702, thereby discriminating whether the print job of the user who activated its own application has been inputted into the print queue or not (step S703). If it is not inputted, the processing routine is finished. If it has been inputted, step S413 follows.

Thus, it is possible that the user who printed is notified of the information regarding the print job and the information regarding the status and the user who does not print is not unnecessarily notified of the information.

Subsequently, a method whereby although the status information is not notified while the printing is normally executed, the status information (in many cases, error information) is notified when an error occurs will be described.

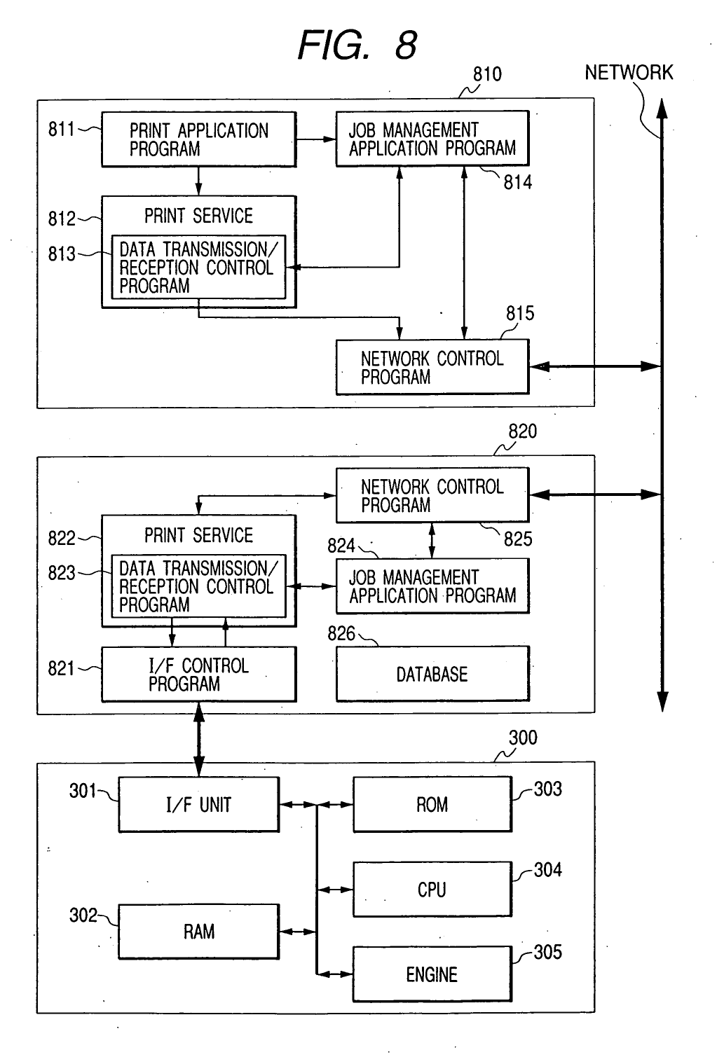

FIG. 8 is a block diagram showing a system of a server client type and showing a system in the case where the user instructs the printing on a client computer. Particularly, when the user instructs the printing from the client computer, there is no need to display the information regarding the print job and the status onto the display of the server computer. However, it is necessary to notify one of the users of the error information by displaying it onto the display of the server computer.

Therefore, the method whereby although the status information is not notified while the printing is normally executed, the status information (in many cases, the error information) is notified when the error occurs will be described with respect to the system of FIG. 8 as a prerequisite. Similar processes can be executed also in the system of FIG. 1.

In FIG. 8, a client computer 810, a server computer 820, and the printer 300 are connected so that they can communicate with each other. The client computer 810 and the server computer 820 are equivalent to the computers shown in FIG. 1. A print application program 811 is equivalent to the print application program 311. Print services 812 and 822 are equivalent to the print service 201. Data transmission/reception control programs 813 and 823 are equivalent to the data transmission/reception control program 313. Job management applications 814 and 824 are equivalent to the job management application 312. An interface control program 821 is equivalent to the interface control program 314. Network control programs 815 and 825 are programs for establishing connection to the network.

When the user instructs the printing by the print application program 811, print data formed by the print service 812 is transmitted to the print service 822 via the network control programs 815 and 825. The data transmission/reception control program 823 transmits a print data block formed by the print service 822 to the printer 300 via the interface control program 821.

The job management application 814 can communicate with the data transmission/reception control program 823 via the network control programs 815 and 825.

The server computer 820 further has a database 826. The database 826 is a database for storing user information. Administrator authorization and the like of the printer have been disclosed in the user information.

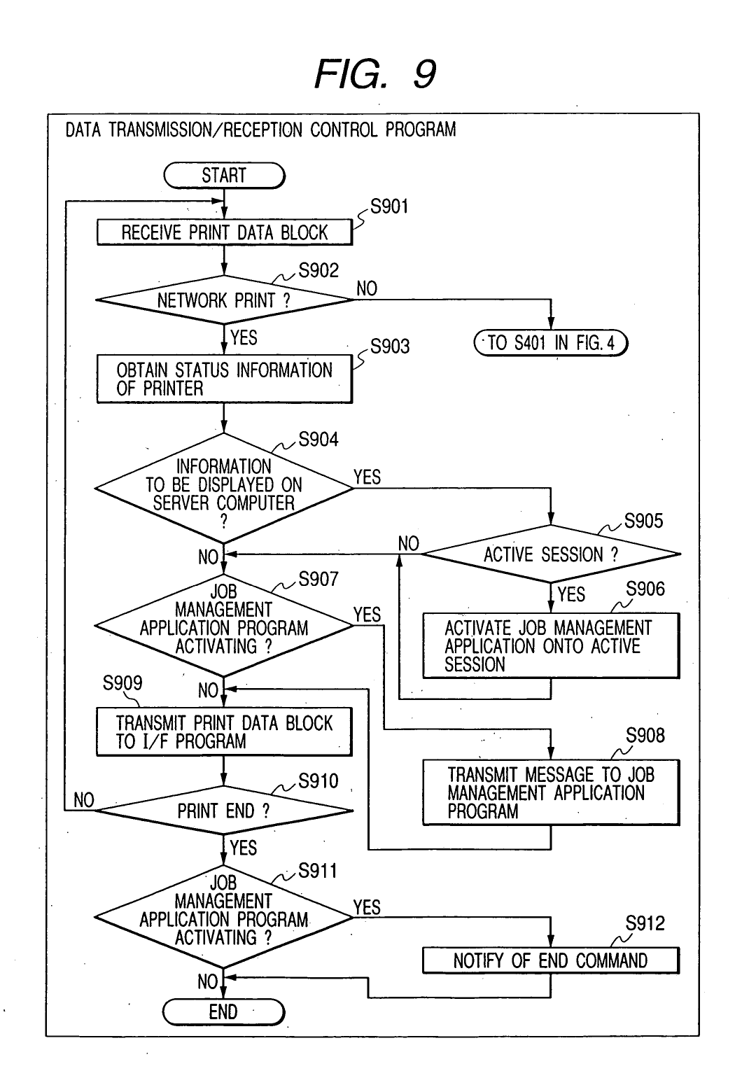

FIG. 9 is a flowchart showing processes which are executed by the data transmission/reception control program 823. When the data transmission/reception control program 823 receives the print data block (step S901), whether the printing is a network printing or a local printing is discriminated (step S902).

The network printing is a printing such that the print data has been transferred via the network. The local printing is a printing such that the print data has been formed in the computer.

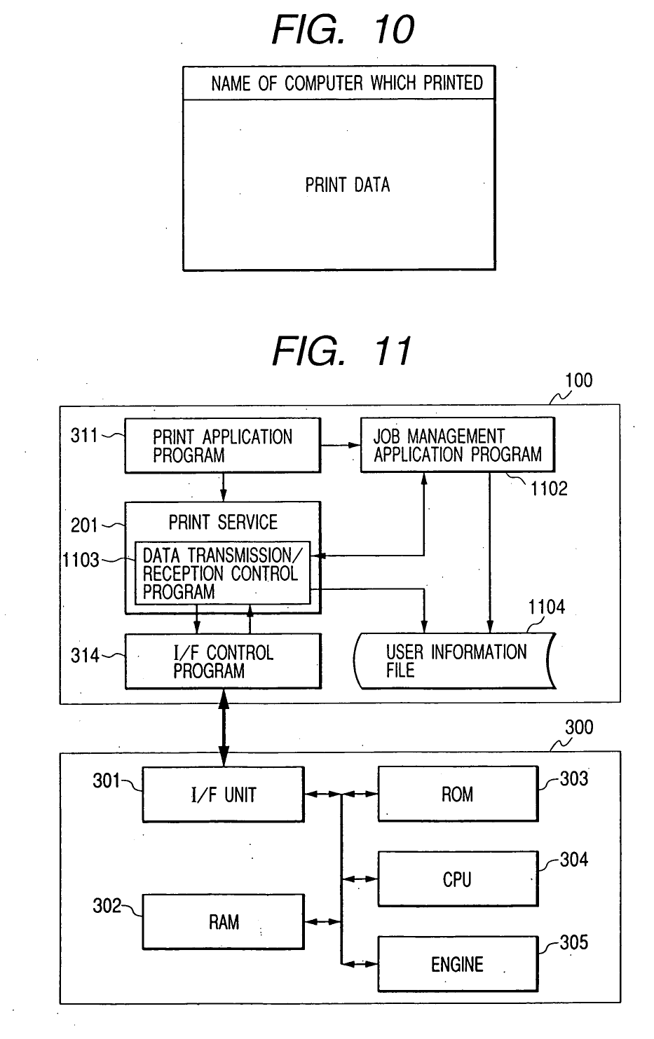

There is a method whereby the computer name is added to the print data in order to discriminate whether the printing is the network printing or the local printing. FIG. 10 is a diagram showing the print data to which the computer name has been added. The data transmission/reception control program 823 analyzes the print data and obtains the computer name. Further, the computer name is obtained also from the OS. Both of the computer names are compared. If they do not coincide, it is determined that the printing is the network printing. If they coincide, it is determined that the printing is the local printing.

In the case of the local printing, step S401 in FIGS. 4A and 4B follows. In the case of the network printing, step S903 follows.

Subsequently, the status information (also including the information regarding the print job) of the printer 300 is obtained via the interface control program 821 (step S903). Whether the obtained status information is information to be displayed on the server computer or not is discriminated (step S904).

If it is the information to be displayed, step S904 follows. The active session information is obtained and whether the user session which is at present the active session exists or not is discriminated (step S905). If the active session exists, a print job management application program is activated in the active session.

Thus, it is enabled to notify one of the users using the server computer of the printer status, particularly, the error of the printer. If the server computer is managed by the network administrator, the network administrator can be notified of the error. If the server computer exists beside the printer 300, the user near the printer 300 can be notified of the error.

The data transmission/reception control program 823 discriminates whether the job management application has been activated or not (step S907). If the job management application has been activated, the obtained status information is transmitted to the job management application as a message (step S908). In FIG. 8, the message is transmitted to the job management applications 814 and 824. In the case of transmitting the message, it is also necessary to transmit the computer name in order to specify to which computer the job management application belongs.

Subsequently, a process for transmitting the print data block to the printer 300 is executed (step S909). After that, whether all print data has been received or not, that is, whether the printing has been finished or not is discriminated (step S910). Whether the job management application has been activated or not is discriminated (step S911). If it has been activated, the message indicative of the end command is transmitted to the job management application (step S912).

Subsequently, if a plurality of users exist, the users who need the information regarding the print job and the printer status and the users who do not need the information exist. Therefore, a method of switching “notify”/“not notify” of the information every user will now be described.

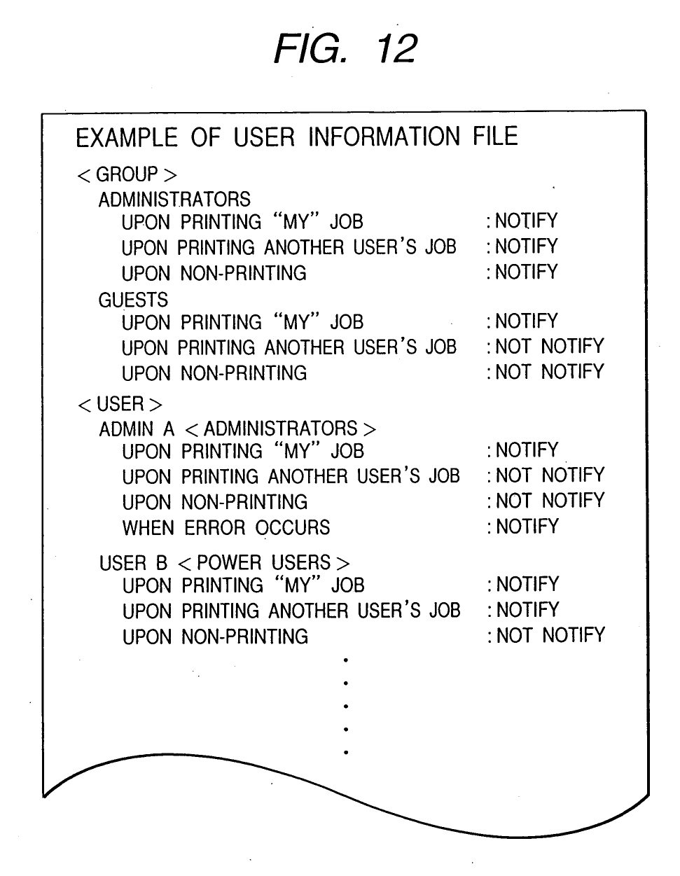

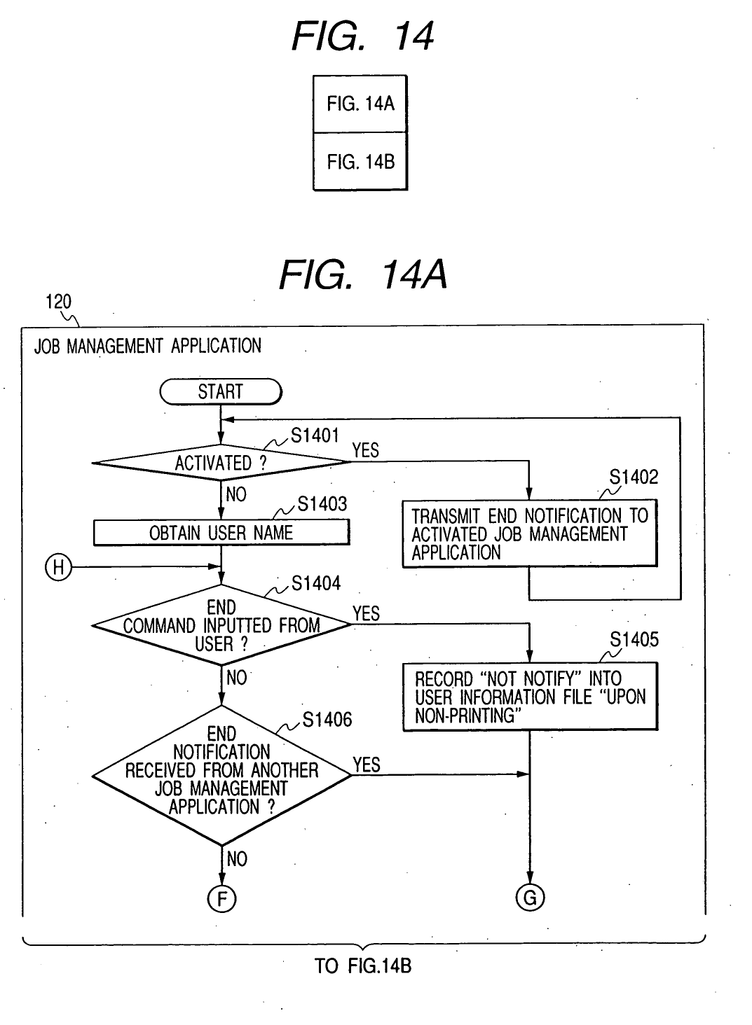

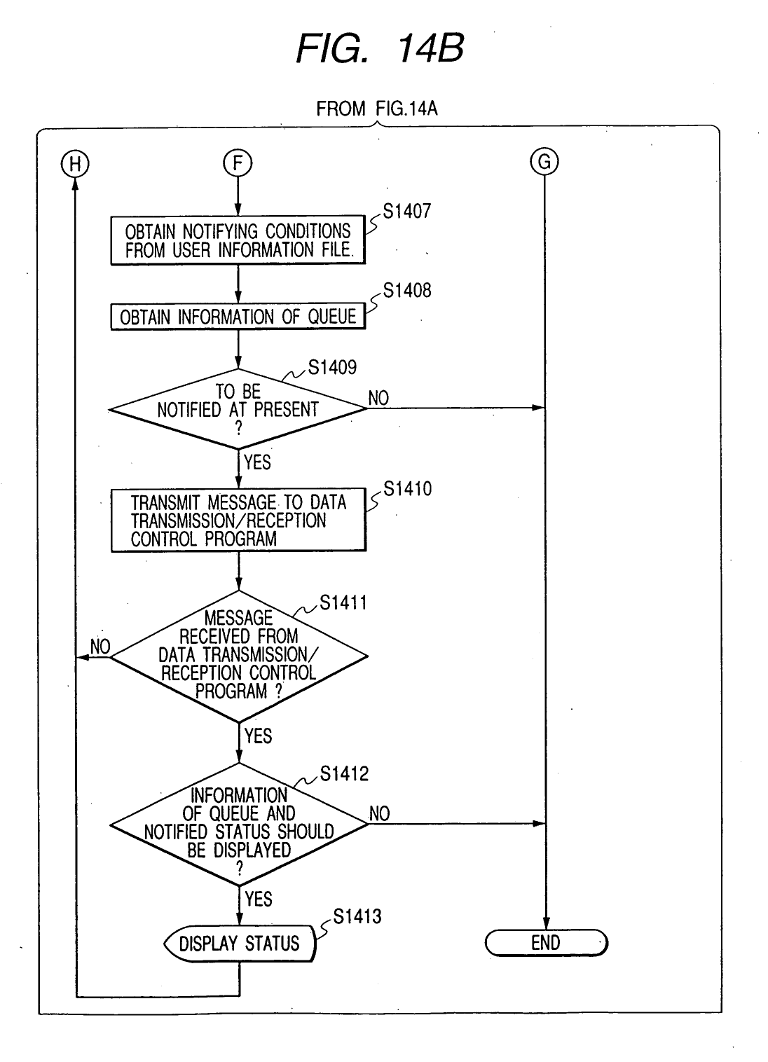

FIG. 11 is a block diagram of the computer which can switch the “notify”/“not notify” of the information every user. FIG. 11 is obtained by adding a user information file 1104 to FIG. 3. A job management application 1102 executes processes shown in a flowchart of FIGS. 14A and 14B in place of the processes shown in the flowchart of FIGS. 4A and 4B. A data transmission/reception control program 1103 executes the processes shown in the flowchart of FIGS. 4A and 4B and also executes processes shown in a flowchart of FIG. 13 at the time of the residence.

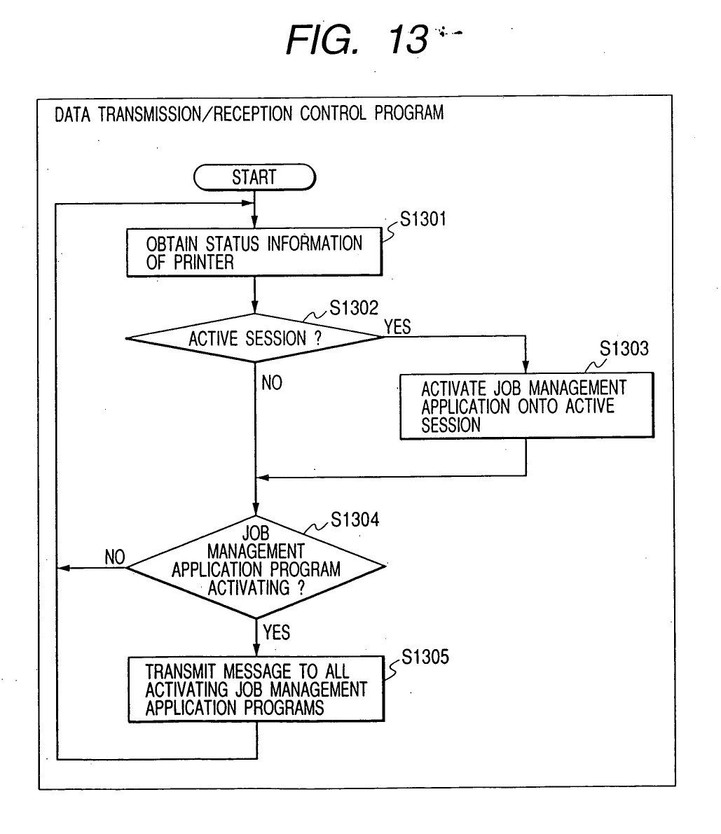

FIG. 12 is a diagram showing an example of the user information file. In the user information file, the item “upon printing “my” job” shows whether the information is notified when the print job of the user exists in the print queue or not. The item “upon printing another user's job” shows whether the information is notified when the print job of another user exists in the print queue or not. The item “upon non-printing” shows whether the information is notified when the print jobs of no users exist or not. The item “when error occurs” shows whether the information is notified when an error occurs or not.

In FIG. 12, the apparatus has been set so that the users belonging to an Administrators group are notified of the information irrespective of the presence or absence of the print job. The apparatus has also been set so that the users belonging to Guests are notified of the information so long as their own print jobs exist. Further, the user AdminA belonging to the Administrators group is notified of the information only in the case where their own print jobs exist or in the case where the error occurs.

The data transmission/reception control program 1103 and the job management application 1102 refer to the user information file. The user information file may be the data transmission/reception control program 1103, the job management application 1102, or the data included in the OS.

FIG. 13 is a flowchart showing processes which are executed by the data transmission/reception control program 1103 at the time of residence.

First, the data transmission/reception control program 1103 obtains the status information (also including the information regarding the print job) of the printer 300 via the interface control program 314 (step S1301).

Subsequently, the active session information is obtained and whether the user session which is at present the active session exists or not is discriminated (step S1302). If the active session does not exist, since there is no need to display the status information, step S1304 follows. If the active session exists, the job management application is activated in the active session (step S1303).

The data transmission/reception control program 1103 receives the message from the job management application in parallel with the series of operations mentioned above and confirms whether the job management application has already been activated or not. Therefore, whether the job management application has already been activated or not is discriminated (step S1304). If it is not activated, step S1301 follows. If the job management application has already been activated, the obtained status information is transmitted to all of the activated job management applications as a message (step S1305).

FIGS. 14A and 14B are flowcharts showing processes which are executed by the job management application 1102.

First, whether another job management application has already been activated in the same user session or not is confirmed (step S1401). If another job management application has been activated, the end notification is made to this job management application (step S1402).

Subsequently, the user name corresponding to the user session in which its own application has been activated is obtained (step S1403). Whether the user has instructed the end or not is discriminated (step S1404). If he has instructed the end, “not notify” is recorded into the item of “upon non-printing” of the column corresponding to the obtained user name in the user information file (step S1405).

Subsequently, whether the end notification has been received from another job management application or not is discriminated (step S1406). If it is not received, notifying conditions of the column corresponding to the obtained user name are obtained from the user information file (step S1407). Further, the information regarding the print queue is obtained (step S1408).

Whether the apparatus is in a state where the status information should be notified or not is discriminated on the basis of the information obtained in steps S1407 and S1408 (step S1409). If it is not in the state where the status information should be notified, the processing routine is finished.

If the apparatus is in the state where the status information should be notified, the message indicative of the existence is transmitted to the data transmission/reception control program 1103 in order to notify the data transmission/reception control program 1103 that its own application has been activated (step S1410).

After that, whether the message has been transmitted from the data transmission/reception control program 1103 or not is discriminated (step S1411). If there is no message, the processing routine is returned to step S1404.

If the message has been transmitted, whether the status should be displayed or not is discriminated on the basis of the information of the print queue, the status information shown by the message, and the notifying conditions of the user information file (step S1412). If it is necessary to display, the information regarding the printer status and the information regarding the print job are displayed onto the display (step S1413).

Thus, the “notify”/“not notify” of the information can be switched every user. The “notify”/“not notify” of the information can be switched in accordance with the set conditions. Those conditions can be changed in accordance with a desire of the user.

As described above, according to the embodiment, in the information processing apparatus which can simultaneously provide the environment, as a user session, in which the user can activate the desired program to each of a plurality of users, the user session which uses the display unit of the information processing apparatus is specified and one of the users can be certainly notified of the necessary information regarding the apparatus in this user session by activating the display program.

If a plurality of display programs have been activated in the specific user session, by finishing one of the plurality of display programs, it is prevented that the program is carelessly activated, and it is possible to prevent that the resources of the system, for example, the processing resources of the CPU and the memory resources are wastefully consumed.

Since the display program is a program for displaying the information regarding the print job issued to the printer or the information regarding the status of the printer, it is possible for even apparatuses which have no means for confirming the information regarding the apparatus in detail and cannot confirm the details without the program in the information processing apparatus to certainly notify one of the users of the information.

By specifying the user corresponding to the user session in which the display program has been activated and discriminating whether the print job of the relevant user has been issued to the printer or not, it is prevented that the user who does not print is unnecessarily notified of the information, and it is possible to notify the user who printed of the information regarding the print job and the information regarding the status and not to unnecessarily notify the user who does not print of the information.

By discriminating whether the apparatus is in the state where it is necessary to display the information regarding the apparatus or not on the basis of the set condition information and the obtained information or by discriminating whether it is necessary to display the information regarding the apparatus or not on the basis of the set condition information and the obtained information, the “notify”/“not notify” of the information can be switched every user. The “notify”/“not notify” of the information can be switched in accordance with the set conditions. Those conditions can be changed in accordance with a desire of the user.

In the case where the print job formed by the first information processing apparatus is transferred to the printer via the second information processing apparatus by using the information processing apparatus which can simultaneously provide the environment, as a user session, in which the user can activate the desired program to each of a plurality of users, whether the information regarding the printer is the information which needs to be displayed onto the display unit of the second information processing apparatus or not is discriminated, and if it is determined that the information needs to be displayed, by activating the display program in the user session using the display unit of the second information processing apparatus, one of the users using the second information processing apparatus can be notified of the information regarding the printer, particularly, the error of the printer. If the second information processing apparatus is managed by the network administrator, the network administrator can be notified of the error. If the second information processing apparatus exists near the printer, the user near the printer can be notified of the error.

1. A notifying method of notifying a user of information regarding an apparatus in an information processing apparatus which can simultaneously provide an environment, as a user session, which can activate a user's desired program to each of a plurality of users, comprising:
an obtaining step of obtaining the information regarding the apparatus;
a specifying step of specifying the user session which uses a display unit of the information processing apparatus; and
an activating step of activating a display program for displaying the information obtained in said obtaining step by the user session specified in said specifying step.

2. A method according to claim 1, further comprising:
a receiving step of receiving existence information showing that the display program has been activated from the display program;
an activation discriminating step of discriminating whether the display program has been activated or not on the basis of said existence information; and
a transmitting step of transmitting the information obtained in said obtaining step to the display program in accordance with a discrimination result showing that the display program has been activated.

3. A method according to claim 1, further comprising a step of, if a plurality of display programs have been activated by the user session specified in said specifying step, finishing one of said plurality of display programs.

4. A method according to claim 1, wherein said display program is a program for displaying information regarding a print job issued to a printing apparatus or information regarding a status of said printing apparatus.

5. A method according to claim 4, further comprising:
a user specifying step of specifying the user corresponding to the user session in which the display program has been activated; and
an issuance discriminating step of discriminating whether the print job of the user specified in said user specifying step has been issued to said printing apparatus or not,
and wherein if it is determined that said print job is not issued, said display program is not activated.

6. A method according to claim 1, further comprising:
a necessity discriminating step of discriminating whether the information is information which needs to be displayed or not on the basis of said information obtained in said obtaining step,
and wherein the display program is activated by the user session specified in said specifying step in accordance with a discrimination result showing that the information is the information which needs to be displayed.

7. A method according to claim 1, further comprising:
a condition obtaining step of obtaining condition information in which conditions in which the information regarding the apparatus is displayed and conditions in which said information is not displayed have been described;
a status discriminating step of discriminating whether the apparatus is in a status where it is necessary to display the information regarding the apparatus or not on the basis of said condition information and the information obtained in said obtaining step; and
a step of finishing the display program in accordance with a discrimination result showing that the apparatus is not in said status.

8. A method according to claim 1, further comprising:
a condition obtaining step of obtaining condition information in which conditions in which the information regarding the apparatus is displayed and conditions in which said information is not displayed have been described; and
a necessity discriminating step of discriminating whether it is necessary to display the information regarding the apparatus or not on the basis of said condition information and the information obtained in said obtaining step,
and wherein if it is determined that it is unnecessary to display the information regarding the apparatus, the display program does not display the information obtained in said obtaining step.

9. A notifying method of notifying the user of information regarding a printing apparatus in an information processing apparatus which can simultaneously provide an environment, as a user session, which can activate a user's desired program to each of a plurality of users, comprising:
a step of transferring a print job formed by a first information processing apparatus to the printing apparatus via a second information processing apparatus;
an obtaining step of obtaining the information regarding the printing apparatus;
a discriminating step of discriminating whether the information obtained in said obtaining step is information which needs to be displayed onto a display unit of said second information processing apparatus or not;
a specifying step of, if it is determined that the information is the information which needs to be displayed, specifying the user session which uses the display unit of said second information processing apparatus; and
an activating step of, if it is determined that the information is the information which needs to be displayed, activating a display program for displaying the information obtained in said obtaining step by the user session specified in said specifying step.

10. A method according to claim 9, further comprising a transmitting step of transmitting the information obtained in said obtaining step to at least one of the display programs activated by said first information processing apparatus and said second information processing apparatus.

11. An information processing apparatus which can simultaneously provide an environment, as a user session, which can activate a user's desired program to each of a plurality of users, comprising:
obtaining means for obtaining information regarding an apparatus;
specifying means for specifying the user session which uses a display unit of said information processing apparatus; and
activating means for activating a display program for displaying the information obtained by said obtaining means in the user session specified by said specifying means.

12. A computer-readable memory medium which stores a program for controlling a computer which can simultaneously provide an environment, as a user session, which can activate a user's desired program to each of a plurality of users, wherein said control program allows the computer to execute:
an obtaining step of obtaining information regarding an apparatus;
a specifying step of specifying the user session which uses a display unit of said computer; and
an activating step of activating a display program for displaying the information obtained in said obtaining step by the user session specified in said specifying step.
